(19) United States
(12) Patent Application Publication
(10) Pub. No.: US 2017/0225203 A1
(43) Pub. Date: Aug. 10, 2017

(54) HIGH-PRESSURE CLEANING SYSTEM AND METHOD FOR OPERATING A HIGH-PRESSURE CLEANING SYSTEM

(71) Applicant: Alfred Kärcher GmbH & Co. KG, Winnenden (DE)

(72) Inventors: Juergen Kloepfer, Burgstetten (DE); Markus Fischer, Winnenden (DE); Swen Munz, Welzheim (DE); Timo Spengler, Weil der Stadt (DE); Sven Dirnberger, Steinheim (DE)

(21) Appl. No.: 15/581,594

(22) Filed: Apr. 28, 2017

Related U.S. Application Data
(63) Continuation of application No. PCT/EP2014/073390, filed on Oct. 30, 2014.

(51) Int. Cl. B08B 3/02; B05B 7/04; B08B 3/08; B05B 1/16; B08B 3/00; B08B 1/00

(52) U.S. Cl. CPC B08B 3/026; B08B 3/003; B08B 1/002; B08B 3/08; B05B 1/16; B05B 7/0408; B08B 2203/0217; B08B 2203/0258; B05B 1/04

(57) ABSTRACT

A high-pressure cleaning system is provided, including a high-pressure cleaning apparatus having a high-pressure pump for increasing the pressure of a cleaning liquid, and two or more discharge units for discharging the cleaning liquid, which are different and can be selectively brought into fluid communication with a pump outlet of the high-pressure pump, wherein the discharge units are connectable to an operating unit or wherein an operating unit is arranged on at least one discharge unit. The high-pressure cleaning system includes an input unit via which at least one output parameter is predeterminable by a user and is adjustable by way of a control unit coupled to the input unit. The high-pressure cleaning system includes an output unit coupled to the control unit and capable of providing an indication depending on the predetermination made by the user, said indication including a recommendation of at least one discharge unit.

### CROSS-REFERENCE TO RELATED APPLICATIONS

This application is a continuation of international application number PCT/EP2014/073390 filed on Oct. 30, 2014, which is incorporated herein by reference in its entirety and for all purposes.

### FIELD OF THE INVENTION

The present invention relates to a high-pressure cleaning system, comprising a high-pressure cleaning apparatus having a high-pressure pump for increasing the pressure of a cleaning liquid, and comprising two or more discharge units, for discharging the cleaning liquid, which are different from each other and which can be selectively brought into fluid communication with a pump outlet of the high-pressure pump, wherein the discharge units are connectable to an operating unit of the high-pressure cleaning system or wherein an operating unit is arranged on at least one discharge unit.

The present invention further relates to a method for operating a high-pressure cleaning system.

### BACKGROUND OF THE INVENTION

High-pressure cleaning systems comprising a high-pressure cleaning apparatus and an operating unit and a discharge unit held thereon which can be brought into fluid communication with a pump outlet of the high-pressure pump are described in DE 10 2006 009 855 A1, US 2013/0214059 A1 and U.S. Pat. No. 5,381,962.

In the field of high-pressure cleaning systems, it is known to provide a plurality of discharge units that can be selectively connected to the operating unit and can thereby be brought into fluid communication with the high-pressure pump. Discharge units are also already known on which a respective operating unit is arranged so that the operating unit together with the discharge unit can be removed by a user and the desired discharge unit brought into fluid communication with the high-pressure pump. Depending on the application, in particular the type and nature of the object to be cleaned and the type of cleaning to be performed (for example coarse cleaning, abrasive cleaning, foam cleaning . . . ), the user selects the appropriate discharge unit in order to achieve as good a cleaning result as possible. Accordingly, the two or more discharge units differ from each other in their discharge characteristics, for example different output pressures of the cleaning liquid, different jet shapes etc. It is desirable that the object to be cleaned not be damaged in the process.

An object underlying the present invention is to provide a high-pressure cleaning system of the kind mentioned at the outset that is easier to handle.

### SUMMARY OF THE INVENTION

In a first aspect of the invention, a high-pressure cleaning system comprises a high-pressure cleaning apparatus having a high-pressure pump for increasing the pressure of a cleaning liquid, and comprises two or more discharge units, for discharging the cleaning liquid, which are different from each other and which can be selectively brought into fluid communication with a pump outlet of the high-pressure pump. The discharge units are connectable to an operating unit of the high-pressure cleaning system or wherein an operating unit is arranged on at least one discharge unit. The high-pressure cleaning system comprises an input unit via which at least one output parameter is predeterminable by a user. The at least one output parameter is adjustable, in accordance with the predetermination, by way of a control unit, coupled to the input unit, of the high-pressure cleaning system. The high-pressure cleaning system comprises an output unit coupled to the control unit, said output unit being capable of providing thereon an indication depending on the predetermination made by the user, said indication comprising a recommendation of at least one discharge unit.

In a second aspect of the invention, a method for operating a high-pressure cleaning system is provided, the high-pressure cleaning system comprising a high-pressure cleaning apparatus having a high-pressure pump for increasing the pressure of a cleaning liquid, and comprising two or more discharge units, for discharging the cleaning liquid, which are different from each other and which can be selectively brought into fluid communication with a pump outlet of the high-pressure pump. The discharge units are connectable to an operating unit of the high-pressure cleaning system or wherein an operating unit is arranged on at least one discharge unit. The high-pressure cleaning system comprises an input unit via which at least one output parameter is predetermined by a user. The at least one output parameter is adjusted, in accordance with the predetermination, by a control unit, coupled to the input unit, of the high-pressure cleaning system. The high-pressure cleaning system comprises an output unit coupled to the control unit, on which output unit an indication depending on the predetermination made by the user is provided, said indication comprising a recommendation of at least one discharge unit.

### BRIEF DESCRIPTION OF THE DRAWINGS

The foregoing summary and the following description may be better understood in conjunction with the drawing figures, of which:

FIG. 1 shows, in a partially schematic view, a preferred embodiment of a high-pressure cleaning system in accordance with the invention, comprising a high-pressure cleaning apparatus, an operating unit, a plurality of discharge units and a portable accessory device;

FIG. 2 shows a further discharge unit of the high-pressure cleaning system of FIG. 1;

FIG. 3 is a view of the discharge unit of FIG. 2 as viewed from the bottom;

FIG. 4 shows symbols which symbolize different operating levels of the high-pressure cleaning apparatus of FIG. 1, wherein at least one output parameter of the high-pressure cleaning apparatus in the different operating levels (1, 2 or 3) assumes a different value or a different range of values;

FIG. 5 is a top view of a combined input/output unit of the high-pressure cleaning system of FIG. 1 with the output parameter “pressure” assuming the operating level 3.

FIG. 6 is a representation corresponding to FIG. 5 with the output parameter “pressure” assuming the operating level 2;

FIG. 7 is a representation corresponding to FIG. 5 with the output parameter “pressure” assuming the operating level 1;

FIG. 8 is a schematic block diagram for explaining the construction and principle of operation of the high-pressure cleaning apparatus of FIG. 1; and

FIG. 9 is a top view of a combined input/output unit that may be used for example in the high-pressure cleaning system of FIG. 1.

### DETAILED DESCRIPTION OF PREFERRED EMBODIMENTS OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a high-pressure cleaning system, comprising a high-pressure cleaning apparatus having a high-pressure pump for increasing the pressure of a cleaning liquid, and comprising two or more discharge units, for discharging the cleaning liquid, which are different from each other and which can be selectively brought into fluid communication with a pump outlet of the high-pressure pump, wherein the discharge units are connectable to an operating unit of the high-pressure cleaning system or wherein an operating unit is arranged on at least one discharge unit. The high-pressure cleaning system comprises an input unit via which at least one output parameter is predeterminable by a user, wherein the at least one output parameter is adjustable, in accordance with the predetermination, by way of a control unit, coupled to the input unit, of the high-pressure cleaning system, and wherein the high-pressure cleaning system comprises an output unit coupled to the control unit, said output unit being capable of providing thereon an indication depending on the predetermination made by the user, said indication comprising a recommendation of at least one discharge unit.

In the high-pressure cleaning system in accordance with the invention, an input unit is provided. The user can predetermine at least one output parameter. Depending on the user's predetermination, the high-pressure cleaning apparatus is adjusted, in particular via an adjustment of an operating point of the high-pressure pump thereof, in accordance with the predetermination made by the user. For example, the user can predetermine the at least one output parameter depending on the type and/or the nature of the object that is to be cleaned and, alternatively or additionally thereto, depending on the desired cleaning operation. Via the output unit, the user can be provided with, for example, a visual or audible indication as to which discharge unit should preferably be used in a particular cleaning operation. It is thereby possible to recommend to the user the use of a discharge unit taking into consideration the predetermination of the at least one output parameter as made by the user. The indication may for example comprise the recommendation of more than only one discharge unit. The indication may for example incorporate the consideration that a particular discharge unit requires, as an output parameter, a minimum pressure in order for a good cleaning result to be achieved. If, for example, a corresponding pressure or pressure range is predetermined as the output parameter by the user, then the appropriate discharge unit can be recommended by the control unit for its use. If, for example, a volumetric flow rate of the cleaning liquid is predetermined as the output parameter, the use of a discharge unit whose nozzle has an opening cross-section large enough for the predetermined volumetric flow rate to be actually delivered therefrom can be recommended via the indication. If, for example, the amount of a cleaning chemical that is admixed to the cleaning liquid is predetermined, a discharge unit that is customarily used for discharging a mixture of a cleaning liquid and a cleaning chemical can be recommended for use via the indication, in order for as good a cleaning result as possible to be achieved. The indication presented on the output unit also serves to prevent potential damage to the object to be cleaned due to the use of an inappropriate discharge unit for the predetermination of the at least one predetermined output parameter.

In an advantageous embodiment of the high-pressure cleaning system in accordance with the invention, it is advantageous for the at least one predeterminable output parameter to comprise the pressure of the cleaning liquid, a volumetric flow rate of the cleaning liquid and/or a dosage of a cleaning chemical capable of being admixed to the cleaning liquid. In particular, provision may be made for the user to be able to predetermine, via the input unit, the pressure, the volumetric flow rate and the dosage independently from one another in each case. It is also conceivable for at least two of these parameters to be predetermined in coupled relation with each other, for example by a user predetermining via the input unit a cleaning profile that comprises the predetermination of at least two output parameters.

Advantageously, the at least one output parameter is controllable by the high-pressure cleaning apparatus depending on the predetermination made by the user. For example, the pressure of the cleaning liquid is sensed by way of a pressure sensor, the volumetric flow rate is sensed by way of a flow sensor and/or the dosage of the cleaning chemical is sensed by way of a concentration sensor, and a corresponding signal is provided to the control unit. Depending on said signal, the control unit can control the pressure, the volumetric flow rate and/or the dosage in accordance with the predetermination by the user.

It has already been mentioned that two or more discharge units can each have an operating unit arranged thereon. The discharge unit can be brought in fluid communication with the pump outlet via the respective operating unit.

Alternatively or in addition, provision may be made for two or more discharge units to be selectively connectable to the operating unit. For example, provision is made for an operating unit in fluid communication with the pump outlet that can have selectively connected thereto one of the two or more discharge units. It is thus possible for more than one discharge unit to be used with only a single operating unit.

Alternatively or in addition, provision may be made for the high-pressure cleaning system to comprise a discharge device which is connectable to the operating unit or on which is arranged an operating unit and which comprises two or more discharge units, one of which can selectively be selected and brought into fluid communication with the pump outlet. The discharge device comprises more than only one discharge unit. The desired discharge unit can be transferred from a position of non-use to a position of use. The respective desired discharge unit can thereby be brought in fluid communication with the pump outlet. Such a discharge device can be arranged on an operating unit or, as mentioned above, it can be selectively connected to an operating unit of the high-pressure cleaning system.

Preferably, the two or more discharge units may comprise at least one of the following:
a high-pressure flat jet nozzle;
a high-pressure rotary nozzle which can in particular emit a high-pressure pinpoint jet that rotates on the curved surface of a cone;
a high-pressure pinpoint jet nozzle;
a low-pressure cleaning agent nozzle whose nozzle opening cross-section is comparatively large in relation to that of the high-pressure flat jet nozzle, the high-pressure rotary nozzle and the high-pressure pinpoint jet nozzle;
a foam nozzle on which is arranged in particular a container for a foamable cleaning chemical;
a wash brush;
a surface cleaner, comprising a hood and a nozzle assembly movably arranged in a receiving space bounded by the hood, said nozzle assembly being capable of being driven by pressurized cleaning liquid.

Advantageously, the at least one output parameter is predeterminable by at least one of the following:
a value or range of values of the at least one output parameter;
an operating level of the high-pressure cleaning apparatus, wherein at least one output parameter has a different value or range of values in different operating levels. For example, the user predetermines an operating level which is linked to the setting of at least one output parameter.
a choice of a cleaning profile, in particular with regard to an object to be cleaned, wherein at least one output parameter has a different value or range of values in different cleaning profiles. For example, by predetermining a cleaning profile, at least one output parameter associated therewith is set.

Provision may be made for a value, a range of values or an operating level to be selected directly or to be increased or reduced by incrementing or decrementing, via the input unit. For example, the operating level is increased or reduced via “+/−” operating elements of the input unit. The value, the range of values and/or the operating level can also be preselected by a corresponding numerical input made through the input unit.

It proves advantageous for two or more operating levels and/or cleaning profiles to be selectably presented or selectably presentable to the user on the input unit in a manner coded by symbols, for example pictograms, that differ from one another. This makes the input unit intuitive to operate. The operating level and/or the cleaning profile can be predetermined by selecting the corresponding symbol. At least one output parameter that is linked to the operating level and/or the cleaning profile can be predetermined.

It is advantageous for the high-pressure cleaning system to comprise a storage unit coupled to or integrated in the control unit in which an operating level and/or a cleaning profile is stored in a manner in which they are selectable via the input unit, wherein a value or range of values of at least one output parameter associated with the operating level or the cleaning profile is stored. The value or range of values of at least one output parameter in a respective operating level and/or in a respective cleaning profile can be stored in the storage unit. Via the selection of the operating level and/or the cleaning profile, the value of the at least one output parameter can be predetermined in a user-friendly manner.

In particular, the contents of the storage unit can be altered. This enables a user to define an operating level and/or a cleaning profile and to store the value or the range of values of at least one output parameter linked therewith. Subsequently, the output parameter can be predetermined in a user-friendly manner by selecting the corresponding operating level and/or the corresponding cleaning profile.

It is advantageous for a preferably wireless data connection to be establishable with a spatially remote data processing device via the control unit and for data relating to an operating level and/or a cleaning profile to be transmittable from the data processing device to the control unit and to be storable in the storage unit for selection by the user. Definitions of an operating level and/or a cleaning profile and the value or range of values of at least one output parameter linked to said operating level and/or cleaning profile can thereby be added to the high-pressure cleaning system in a particularly user-friendly manner. For example, the user can initiate the establishment of a data connection from the control unit to the data processing device via the input unit. The data processing device, which is for example owned or administered by a manufacturer of the high-pressure cleaning system, may know predefined operating levels and/or cleaning profiles. The corresponding data via which the value of at least one output parameter is adjusted can be transmitted (in particular downloaded) from the data processing device to, for example, the control unit and stored in the storage unit. These data can for example also comprise the above-mentioned symbols, in particular pictograms, that can be used for selecting the operating level and/or the cleaning profile.

The output unit preferably is or comprises a visual output unit, and the indication, in particular the recommendation, can preferably be presented on the output unit. The visual output unit enables the indication to be provided in a simple and user-friendly manner. For example, the recommended discharge unit is presented on the output unit in text form or symbol form or pictogram form.

Advantageously, the user's predetermination of the at least one output parameter can be presented on the output unit. For example, the user thereby receives, at the output unit, feedback indicating which value or range of values of the at least one output parameter, which operating level and/or which cleaning profile he or she has predetermined.

The input unit may comprise for example at least one switch, button, rotary knob, key or other type of operating element.

In an advantageous embodiment of the cleaning system in accordance with the invention, the input unit comprises at least one touch-sensitive screen (touch screen) for predetermining the at least one output parameter. On the screen, for example, an operating level and/or a cleaning profile is presented in a coded manner using a symbol or pictogram. By operating the touch screen, a value or range of values of at least one parameter that is linked to the operating level and/or the cleaning profile is predetermined.

The input unit and the output unit preferably form an integrated input/output unit, wherein this preferably comprises a touch-sensitive screen for receiving the predetermination and outputting the indication. Here, the term “integrated” can be taken to mean, in particular, that the integrated units are arranged in a common housing. By way of example, provision is made for an enclosed and in particular waterproof integrated unit.

It proves advantageous for the control unit to form, at least in part, an integrated unit with the input unit and/or with the output unit. For example, an integrated control/input/output unit is provided which is arranged in an enclosed, waterproof housing. The control unit can, at least in part, form an integrated unit with the input unit and/or the output unit. This is advantageous for example where said integrated unit is arranged on an operating unit or on an external accessory device. A further part of the control unit can, especially in these two cases, be arranged for example in the high-pressure cleaning apparatus and control the high-pressure pump thereof in order to set the at least one output parameter.

It proves advantageous for the input unit and/or the output unit and/or the control unit to be, at least in part, arranged on or comprised by the operating unit. This facilitates to the user the handling of the system by enabling him or her to enter inputs on the operating unit and/or to receive outputs at the operating unit.

Alternatively or in addition, provision may be made for the input unit and/or the output unit and/or the control unit to be, at least in part, arranged on or comprised by the high-pressure cleaning apparatus.

Alternatively or in addition, provision may be made for the input unit and/or the output unit and/or the control unit to be, at least in part, arranged on or comprised by a preferably portable accessory device, in particular a portable computer or a smartphone. This makes the high-pressure cleaning system particularly user-friendly to handle. The preferably portable accessory device offers for example the possibility of establishing a data connection to the external data processing device and transmitting data relating to an operating level and/or a cleaning profile for storage thereof in the storage unit, as has been described above.

In accordance with the above embodiments, provision may be made for the high-pressure cleaning system to comprise more than only one input unit and/or more than only one output unit. The control unit may, at least in part, be arranged in or comprised by the operating unit, the high-pressure cleaning apparatus and/or the accessory device.

It is advantageous for data to be transmittable wirelessly from the operating unit and/or from the accessory device to the high-pressure cleaning apparatus and/or vice versa. For example, a radio communication link is used in order for the predetermination effected by the user on the operating unit and/or on the accessory device to be transmitted to a control unit or to a part thereof in the high-pressure cleaning apparatus.

It proves advantageous for the high-pressure cleaning system to comprise a detection unit coupled to the control unit with which the discharge unit that is connected to the operating unit or the discharge unit that is arranged on the operating unit can be determined.

The detection unit is for example arranged on the operating unit or comprised thereby.

Detection of the at least one discharge unit may for example be realized using at least one of a mechanical, electrical, contact-based, wireless and radio communication (for example RFID) technique.

The detection unit makes it possible to determine whether a discharge unit may have been provided that deviates from the recommendation on the output unit. Preferably, when the discharge unit deviates from a discharge unit in accordance with the recommendation, a corresponding indication, for example visual or audible, can be provided by the control unit on the output unit. The user can thereby be alerted to check the choice of the output unit.

As mentioned at the outset, the present invention further relates to a method. In accordance with the invention, a method for operating a high-pressure cleaning system is provided, the high-pressure cleaning system comprising a high-pressure cleaning apparatus having a high-pressure pump for increasing the pressure of a cleaning liquid, and comprising two or more discharge units, for discharging the cleaning liquid, which are different from each other and which can be selectively brought into fluid communication with a pump outlet of the high-pressure pump, wherein the discharge units are connectable to an operating unit of the high-pressure cleaning system or wherein an operating unit is arranged on at least one discharge unit, wherein the high-pressure cleaning system comprises an input unit via which at least one output parameter is predetermined by a user, wherein the at least one output parameter is adjusted, in accordance with the predetermination, by a control unit, coupled to the input unit, of the high-pressure cleaning system, and wherein the high-pressure cleaning system comprises an output unit coupled to the control unit, on which output unit an indication depending on the predetermination made by the user is provided, said indication comprising a recommendation of at least one discharge unit.

The advantages that have already been mentioned in the context of the description of the high-pressure cleaning system in accordance with the invention can be achieved by use of the method. Therefore, in order to avoid repetition, reference can be made to the foregoing explanations.

Advantageous exemplary embodiments of the method in accordance with the invention will be apparent from advantageous embodiments of the high-pressure cleaning system in accordance with the invention and use thereof. The features of the advantageous embodiments may be used to define advantageous exemplary embodiments of the method.

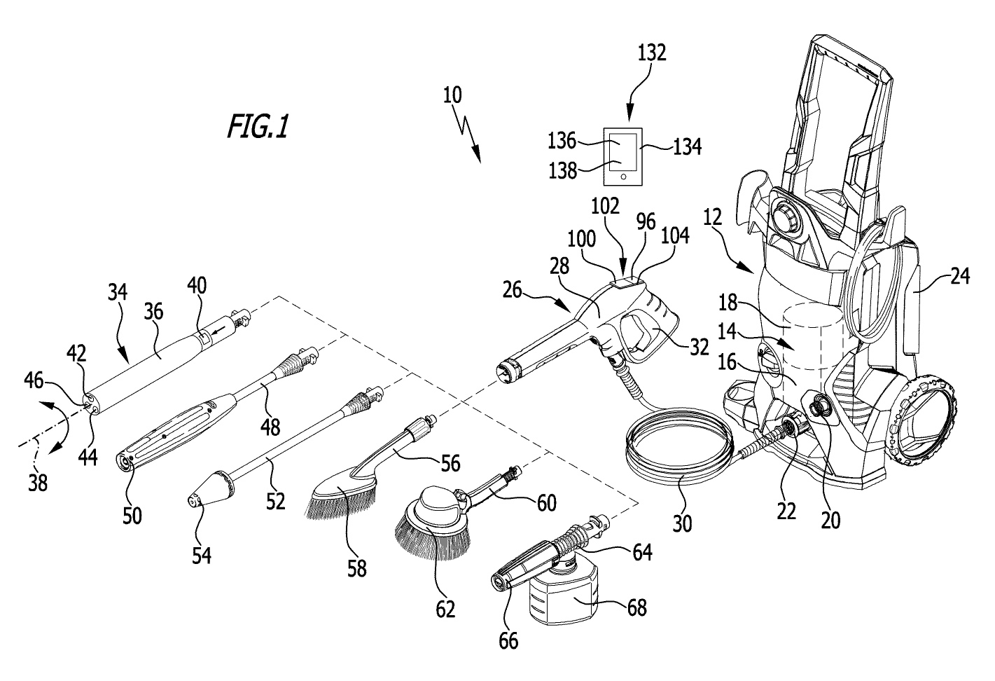

FIG. 1 shows an advantageous embodiment of a high-pressure cleaning system in accordance with the invention, designated by the reference numeral 10. The high-pressure cleaning system comprises a high-pressure cleaning apparatus 12 comprising a motor pump unit 14. The motor pump unit 14 comprises a high-pressure pump 16 and a drive motor 18 for the latter. A cleaning liquid that is to be pressurized, in particular water, can be supplied to the high-pressure pump 16 via a pump inlet 20. The cleaning liquid that has been pressurized to high pressure can be discharged from the high-pressure pump 16 at a pump outlet 22 thereof.

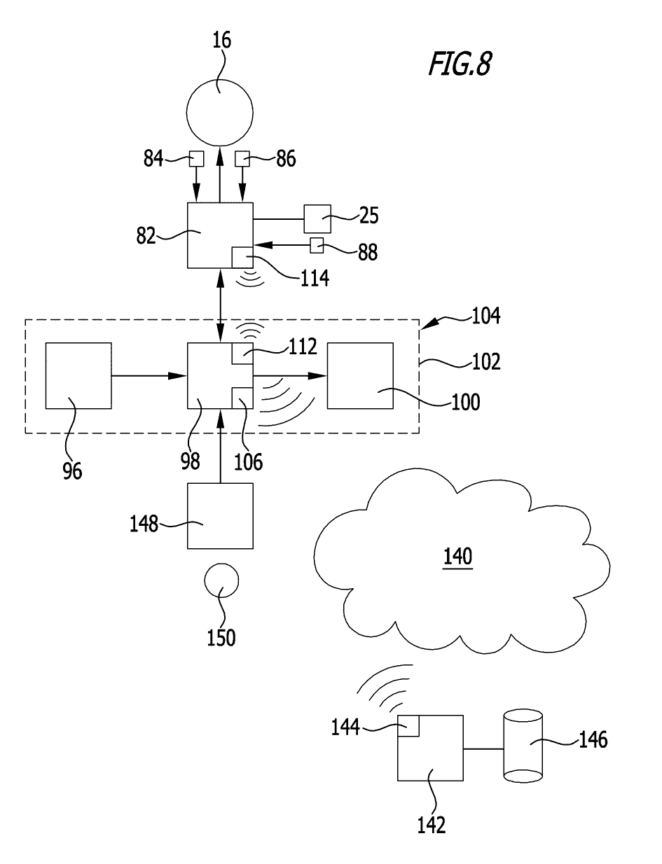

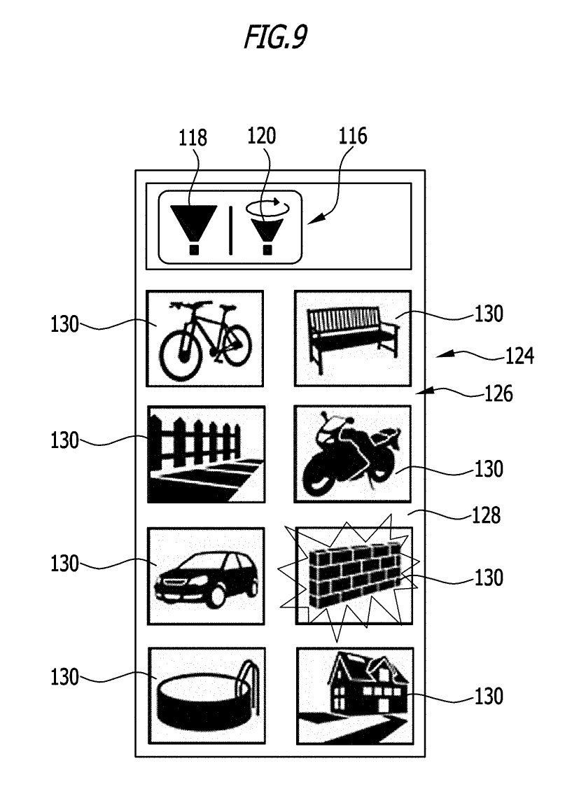

Arranged on the high-pressure cleaning apparatus 12 is a container 24 which holds a store of a cleaning chemical. A cleaning chemical can be admixed to the cleaning liquid via an admixing device 25 (FIG. 8) in order to enhance the cleaning performance of the cleaning liquid. The admixing device 25 can be controlled so that the dosage of the cleaning chemical can be adjusted.

The high-pressure cleaning system 10 comprises an operating unit 26 in the form of a high-pressure gun 28. The gun 28 can be connected to the pump outlet 22 via a high-pressure conduit 30. An operating element in the form of a trigger 32, when operated, opens a valve arranged in the gun 28. Pressurized cleaning liquid can thereby be discharged from the gun 28. The high-pressure cleaning system 10 further comprises a discharge device 34 that can be releasably connected to the operating unit 26. The discharge device 34 comprises three discharge units that are arranged in a common housing 36. The housing 36 can be rotated about a longitudinal axis 38 of the discharge device 34, for example. This provides the possibility of selectively bringing one of the three discharge units of the discharge device 34 in fluid communication with the pump outlet 22. When the corresponding discharge unit assumes a position of use, a fluid conduit comprised thereby is in alignment with a fluid conduit of the gun 28 to which the discharge device 34 is connected. Thus, by rotating the housing 36 about the longitudinal axis 38, one of the three discharge units at the user's choice can be brought in fluid communication with the pump outlet 22 via the gun 28.

An indication as to which discharge unit assumes the position of use in each case and which other two discharge units are in the position of non-use in each case is given to the user by indicia 40 provided on the housing 36, for example. The indicia 40 comprises an individual symbol associated with each discharge unit and easily visible to the user.

In particular, the discharge device 34 comprises a high-pressure flat jet nozzle 42 for emitting a fan-shaped cleaning jet. The discharge device 34 further comprises a high-pressure rotary nozzle 44 through which a high-pressure pinpoint jet that rotates on the curved surface of a cone can be emitted. The discharge device 34 further comprises a low-pressure cleaning agent nozzle 46. The nozzle opening cross-sectional area of the cleaning agent nozzle 46 is substantially larger than the respective nozzle opening cross-sectional area of the flat jet nozzle 42 and the rotary nozzle 44. The cleaning agent nozzle 46 allows for emission of a high-volume flow rate cleaning jet under less pressure than with the two other nozzles 42, 44.

The high-pressure cleaning system 10 comprises multiple further discharge units which may, in lieu of the discharge device 34, be selectively connected to the gun 28. It is thereby possible for each of the discharge units to be brought into fluid communication with the pump outlet 22 via the gun 28.

A discharge unit 48 is provided which comprises a high-pressure flat jet nozzle 50.

Further provided is a discharge unit 52 which comprises a high-pressure rotary nozzle 54.

Also provided are discharge units 56 and 60 which comprise wash brushes 58 and 62 respectively, wherein the wash brushes 58, 62 differ from each other with regard to their shape and function.

Additionally, a discharge unit 64 is provided. The discharge unit 64 comprises a foam nozzle 66. The foam nozzle 66 allows cleaning liquid which can have a foam-producing cleaning chemical admixed thereto from a container 68 of the discharge unit 64 to be foamed.

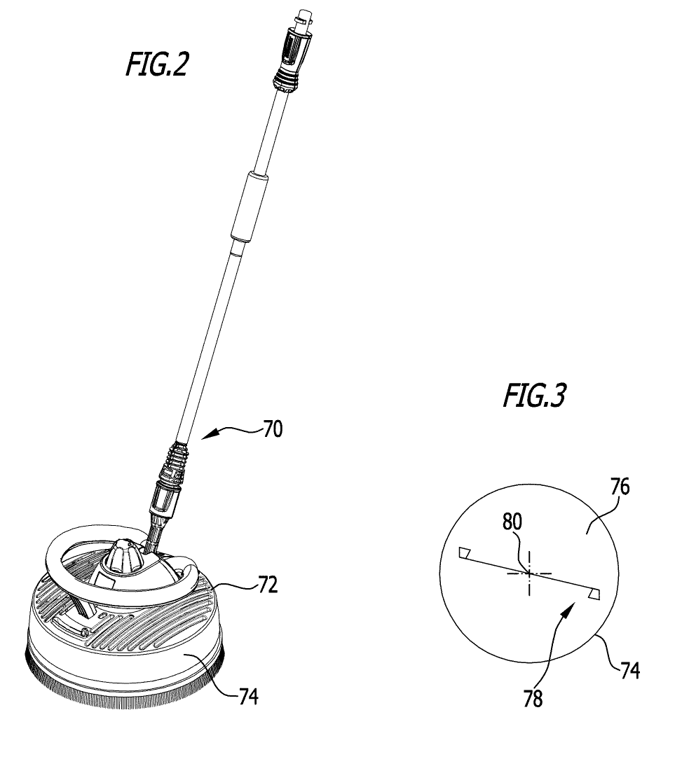

FIGS. 2 and 3 show a further discharge unit 70 in the form of a surface cleaner 72 which can likewise be selectively connected to the gun 28 and brought into fluid communication with the pump outlet 22. The surface cleaner 72 comprises at the working end a hood 74 which bounds a receiving space 76. Provided in the receiving space 76 is a nozzle assembly 78 which is supported for rotation about an axis 80 on the hood 74. The nozzle assembly 78 is caused to rotate by the action of the cleaning liquid and applies same to a surface that is to be cleaned.

Depending on the type and nature of the object to be cleaned and/or depending on the type of cleaning (for example coarse cleaning, abrasive cleaning, foam cleaning, brush cleaning . . . ), the user may connect the discharge device 34, with the corresponding discharge unit thereof, or one of the other discharge units 48, 52, 56, 60, 64 or 70 to the gun 28 and apply the cleaning liquid, which may have a cleaning chemical admixed thereto and/or be foamed, to the object to be cleaned.

Here it is desirable that, depending on the type and nature of the object and depending on the type of cleaning, as good a cleaning result as possible be achieved and damage to the object be avoided as much as possible.

The different discharge units of the cleaning system 10 have different discharge characteristics for achieving different cleaning results. However, provision may be made for the high-pressure flat jet nozzles 42 and 50 on the one hand and the high-pressure rotary nozzles 44 and 54 on the other hand to have identical discharge characteristics.

As is apparent from FIG. 8 in particular, the high-pressure cleaning system 10 comprises a control unit 82 in the high-pressure cleaning apparatus 12. The control unit 82 allows for the high-pressure pump 16 to be controlled in order to adjust the cleaning liquid pressure provided thereby. Alternatively or in addition, the volumetric flow rate of the cleaning liquid can be adjusted.

A pressure sensor 84 and a flow sensor 86 send a pressure signal and a signal relating to the volumetric flow rate respectively to the control unit 82. Taking into consideration said respective signal, the control unit 82 can control the pressure or the volumetric flow rate depending on the respective value or range of values predetermined for the control unit 82.

Furthermore, the control unit 82 is coupled to the admixing device 25 in order to adjust the dosage of the cleaning chemical from the container 24. The signal of a concentration sensor 88 by which the dosage of the cleaning chemical in the cleaning liquid can be determined can be supplied to the control unit 82. This allows the cleaning chemical dosage to be controlled depending on the value or range of values supplied to the control unit 82.

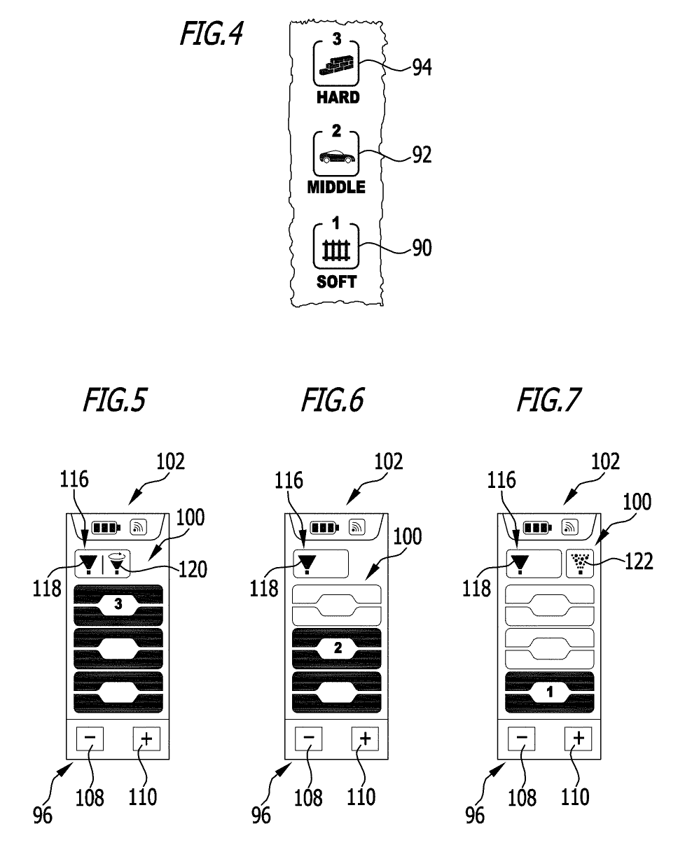

The pressure, the volumetric flow rate and the cleaning chemical dosage are output parameters of the high-pressure cleaning apparatus 12. In the high-pressure cleaning apparatus 12, at least one output parameter can be predetermined by a user. This will be explained in the following with reference to FIGS. 4 to 8 in particular. The explanation will be given using the output parameter “pressure of the cleaning liquid” as an example. However, the following explanations apply analogously to the output parameter “volumetric flow rate” and to the output parameter “dosage of the cleaning chemical”.

Furthermore, the following explanation of the invention will be given using as an example the discharge device 34 including the three different discharge units which can be selectively transferred to a position of use. However, the following explanations apply analogously to the other discharge units 48, 52, 56, 60, 64 and 70 of the high-pressure cleaning system 10, too.

The exemplary limitation of the explanation of the invention to the pressure of the cleaning liquid and to the use of the discharge device 34 is non-limiting for the present invention.

In the way of an example, FIG. 4 shows three symbols 90, 92 and 94 as they may for example appear depicted in the instructions for use of the high-pressure cleaning system 10 in order to facilitate the handling thereof to the user. It is also conceivable for depictions of the symbols 90, 92, 94 to be provided on the high-pressure cleaning apparatus 12 and/or the operating unit 26.

The symbol 90 symbolizes an operating level “1” of the high-pressure cleaning apparatus 12. It tells the user that the operating level “1” is preferably intended for cleaning relatively “soft” (for example delicate) objects. The symbol 90 comprises the pictogram of a garden fence for example.

The symbol 92 symbolizes an operating level “2” of the high-pressure cleaning apparatus 12. It tells the user that the operating level “2” is preferably intended for cleaning relatively “medium-hard” objects (for example with normal durability). By way of example, the symbol 92 comprises the pictogram of a motor vehicle.

The symbol 94 symbolizes an operating level “3” of the high-pressure cleaning apparatus 12. It tells the user that the operating level “3” is preferably intended for cleaning relatively “hard” (for example highly durable) objects. By way of example, the symbol 94 comprises the pictogram of brickwork.

The high-pressure cleaning apparatus 12 may be operated in the three different operating levels “1, 2, 3”. The respective pressure of the cleaning liquid that is provided by the high-pressure pump 16 is different in each operating level. In particular, each operating level comprises a range of values for the output parameter “pressure” that differs from the range of values of the other operating levels. The pressure of the cleaning liquid will be lowest in operating level “1”, higher in operating level “2” and highest in operating level “3”.

In addition to the operating levels “1, 2, 3”, intermediate levels are provided, namely operating levels “1.5” and “2.5”. In operating level “1.5”, the range of values of the output parameter “pressure” is higher than that associated with operating level “1” but lower than that related to operating level “2”. Correspondingly, the range of values of the output parameter “pressure” related to operating level “2.5” is higher than that associated with operating level “2” but lower than that associated with operating level “3”.

The high-pressure cleaning system 10 comprises an input unit 96, a control unit 98 coupled thereto and an output unit 100 coupled to the control unit 98. In the present case, the input unit 96, the control unit 98 and the output unit 100 are integrated as an integrated unit 102.

By way of example, the unit 102 is housed in an enclosed and in particular waterproof housing 104. In the present case, the integrated unit 102 is arranged on the gun 28, for example close to the trigger 32. The user can thereby easily observe the output unit 100 and easily operate the input unit 96.

It is also conceivable for an input unit and an output unit 100 to be arranged on the high-pressure cleaning apparatus 12, as has already been described above.

The control unit 98 may communicate with the control unit 82 in the high-pressure cleaning apparatus 12. In particular, communication may be wireless, for example by radio. To this end, the control unit 98 and the control unit 82 comprise radio members 112 and 114 respectively.

In particular, the control unit 98 and the control unit 82 may be regarded as parts of a common control unit of the high-pressure cleaning system 10 that are spatially separated from each other in the unit 102 on the one hand and in the high-pressure cleaning apparatus 12 on the other.

Integrated in the control unit 98 is a storage unit 106.

In the present case, the input unit 96 comprises operating elements in the form of keys 108, 110. The key 108 is labeled with the “−” symbol and the key 110 is labeled with the “+” symbol.

The output unit 100 in the present case is a visual output unit for visually presenting information relating to the status of the high-pressure cleaning system 10, in particular the operating level assumed thereby. Furthermore, the output unit 100 comprises an indication indicative of a recommendation as to which of the discharge units of the discharge device 34 should be used depending on a particular operating level that is predetermined by the user on the input unit 96. This will be explained in the following.

Using the keys 108, 110, the user can predetermine the operating levels “1/1.5/2/2.5/3” of the high-pressure cleaning apparatus 12 incrementally (key 110) or decrementally (key 108). In doing so, the user can receive guidance by the symbols 90, 92 and 94, for example. The predetermination effected by the user is transmitted to the control unit 98. The range of values for the pressure that is associated with the respective predetermined operating level is read from the storage unit 106, and a corresponding signal is transmitted wirelessly to the control unit 82. The control unit 82 can control the high-pressure pump 16. As mentioned above, the pressure of the cleaning liquid can be controlled.

It is also conceivable that the operating level predetermined by the user is transmitted to the control unit 82 and that a range of values of the pressure which is associated with said operating level is read from a storage unit of the control unit 82 and used as a basis for the pressure control.

On the one hand, the control unit 82 can provide, via the output unit 100, a visual presentation of the predetermination of the selected output parameter “pressure”, symbolized by the operating level. For example, in FIG. 5 the operating level “3” (hard) is illustrated, which has been predetermined by the user.

Further provided on the output unit 100 is an indication that comprises the recommendation of at least one discharge unit, said indication being dependent on the user's predetermination of the output parameter “pressure”.

In the example of FIG. 5, it is shown that an indication 116 is provided for the selected operating level “3”. The indication 116 comprises a first recommendation which comprises a symbol 118. In addition thereto, a second recommendation is provided which comprises a symbol 120.

The symbol 118 symbolizes a high-pressure flat jet nozzle. It recommends to the user that he or she use a discharge unit comprising a high-pressure flat jet nozzle when in operating level “3”.

The symbol 120 symbolizes a high-pressure rotary nozzle. It symbolizes to the user that he or she could alternatively use a discharge unit comprising a high-pressure rotary nozzle when in operating level “3”.

In the context of the presently assumed use of the discharge device 34, the user may use the discharge unit thereof comprising the high-pressure flat jet nozzle 42 or the discharge unit thereof comprising the high-pressure rotary nozzle 44 in order to conform to the indication 116. The user can verify the correct choice of the discharge unit via the indicia 40.

Alternatively, in lieu of the discharge units comprising the nozzles 42 and 44, the discharge unit 48 comprising the nozzle 50 or the discharge unit 52 comprising the nozzle 54 may be connected to the gun 28.

The indication 116 serves the purpose of recommending to the user a discharge unit that is best suited to the selected operating level in order for as good a cleaning result as possible to be achieved on the one hand and for damage to the object to be cleaned to be avoided as much as possible on the other hand.

This will be explained in greater detail below with reference to FIG. 6. In the example of FIG. 6, the user has selected, via the input unit 96, the operating level “2”, which is linked to a lower range of values for the output parameter “pressure”. In this case, the indication 116 comprises only one recommendation, namely by presentation of the symbol 118 which relates to a high-pressure flat jet nozzle 42. It is thereby symbolized to the user that the discharge unit comprising the high-pressure flat jet nozzle 42 of the discharge device 34 should be used. Alternatively, the discharge unit 48 comprising the high-pressure flat jet nozzle 50 could also be used.

The symbol 120 and therefore a recommendation for use of a high-pressure rotary nozzle 44 is omitted in the present case because, for example, the high-pressure rotary nozzle, for achieving an optimum cleaning effect, requires a pressure of the cleaning liquid that exceeds the pressure in operating level “2”. The recommendation indicated via the symbol 120 can also be omitted because, for example, for the underlying application, namely the cleaning of a “medium-hard” object, there is a concern that the latter may be damaged when using a high-pressure rotary nozzle on it.

The invention is further explained with reference to FIG. 7 where the state of assuming the operating level “1” is symbolized according to the user's predetermination on the input unit 96. Depending on the predetermination, the indication 116 again comprises, via the symbol 118, the recommendation for use of a high-pressure flat jet nozzle. Furthermore, the indication 116 comprises the recommendation for use of a low-pressure cleaning agent nozzle, via a corresponding symbol 122.

Accordingly, it is symbolized to the user that, when in operating level “1”, the discharge units comprising the high-pressure flat jet nozzle 42 or the low-pressure cleaning agent nozzle 46 of the discharge device 34 could be used. Alternatively, the discharge unit 48 comprising the high-pressure flat jet nozzle 50 could be used.

When in operating level “1”, a cleaning chemical can be added via the admixing device 25.

The high-pressure cleaning system 10 in accordance with the invention is distinguished by being particularly user-friendly to handle. On the one hand, it gives the possibility of predetermining at least one output parameter via the input unit 96. In accordance with the predetermination by the user, the high-pressure cleaning apparatus 12 adjusts the desired output parameter as predetermined. On the other hand, the user is provided with feedback via the output unit 100, this comprising the indication 116 and, hence, a recommendation for the use of the discharge unit best suited. The cleaning result can thereby be optimized and the risk of damage occurring to the object to be cleaned can be reduced.

FIG. 9 shows in a schematic top view a representation of an integrated unit 124 that could be used with the high-pressure cleaning system 10 in place of the integrated unit 102. The integrated unit 124 comprises an integrated input/output unit 126 which in the present case is configured as a touch-sensitive screen (touch screen 128). Furthermore, the control unit 98 is integrated in the unit 124 (not shown).

Presented on the touch screen 128 are a plurality of symbols 130, in particular pictograms. Each symbol 130 is linked to a cleaning profile that is stored for example in the storage unit 106 or in the storage unit of the control unit 82. Each cleaning profile is linked to a range of values, in particular of the output parameter “pressure”. Furthermore and with reference to previous embodiments, linkage may also exist to a further output parameter, such as the volumetric flow rate and/or the dosage of the cleaning chemical.

The user can predetermine at least one output parameter by selecting the corresponding symbol 130 on the touch screen 128. The status of the high-pressure cleaning apparatus 12 is adjusted under the control of the control unit 82. Depending on the predetermination by the user, the indication 116 is output on the touch screen 128.

In the example of FIG. 9, the user has selected the symbol 130 for “brickwork”, which is visually highlighted. Linked to the cleaning profile for “brickwork” is a comparatively high pressure of the cleaning liquid, similar for example to that in operating level “3” from the previous example.

Accordingly, the indication 116 in the example of FIG. 9 comprises the recommendation comprising the symbol 118 for use of a discharge unit comprising a high-pressure flat jet nozzle and the recommendation comprising the symbol 120 for use of a discharge unit comprising a high-pressure rotary nozzle.

Shown in FIG. 1 is an accessory device 132 as a further component of the high-pressure cleaning system. The accessory device, preferably a portable one, is for example a portable computer or a smartphone 134. The smartphone 134 can be used as an alternative or in addition to the integrated unit 102 or 124. The touch screen 138 can be used as an integrated input/output unit 136. An internal data processing device of the smartphone 134 can be used in lieu of the control unit 98.

Where the smartphone 134 is used for predetermining at least one output parameter, input to and output from the touch screen 138 are realized for example as described above in the context of the example of FIG. 9 and the touch screen 128.

In an advantageous embodiment, the control unit 98 and/or the internal control unit of the smartphone 134 can establish a wireless data connection over a communication network 140 (for example the Internet) with a spatially remote data processing device 142. To this end, the latter comprises for example a radio member 144 for communication with the radio member 112 or a radio member of the smartphone 134.

The data processing device 142 is for example owned or administered by a manufacturer of the high-pressure cleaning system 10 and is coupled to a database 146. For example, the database 146 can have cleaning profiles stored therein. As used herein, this means in particular that the corresponding cleaning profile comprises a predetermination of a value or range of values of at least one output parameter. Data that comprise the definition of a cleaning profile can be transmitted over the communication network 140 to the control unit 98 or to the smartphone 134 and be stored in the storage unit 106 or in the storage device of the smartphone 134 respectively. Accordingly, the cleaning profile can be downloaded. For example, the cleaning profile further comprises a symbol 130 for presentation on the touch screen 128 or 138 respectively.

As has been described above, the user can make a predetermination of at least one output parameter of the high-pressure cleaning apparatus 12 by selecting the corresponding symbol 130.

Furthermore, the high-pressure cleaning system 10 may comprise a detection unit 148. The detection unit 148 is for example arranged on the gun 28 and coupled to the control unit 98 or to the data processing device of the smartphone 134.

The detection unit 148 enables detection of which particular discharge unit is connected to the gun 28 or which of the discharge units of the discharge device 34 assumes the position of use. FIG. 8 schematically shows a discharge unit 150.

If the discharge unit detected deviates from the discharge unit according to the indication 116, the user can be provided with a corresponding indication. By way of example, an indication is presented on the output unit 100. It is also possible for the high-pressure cleaning apparatus 12 and/or the gun 28 to inhibit the discharge of cleaning liquid until a discharge unit in conformance with the indication 116 has been connected to the gun 28 or selected.

The detection unit 148 may detect the discharge unit by contact or non-contact techniques, using for example mechanical, electrical or other types of techniques. By way of example, contactless detection occurs by RFID technology.

1. A high-pressure cleaning system, comprising a high-pressure cleaning apparatus having a high-pressure pump for increasing the pressure of a cleaning liquid, and comprising two or more discharge units, for discharging the cleaning liquid, which are different from each other and which can be selectively brought into fluid communication with a pump outlet of the high-pressure pump, wherein the discharge units are connectable to an operating unit of the high-pressure cleaning system or wherein an operating unit is arranged on at least one discharge unit, wherein the high-pressure cleaning system comprises an input unit via which at least one output parameter is predeterminable by a user, wherein the at least one output parameter is adjustable, in accordance with the predetermination, by way of a control unit, coupled to the input unit, of the high-pressure cleaning system, and wherein the high-pressure cleaning system comprises an output unit coupled to the control unit, said output unit being capable of providing thereon an indication depending on the predetermination made by the user, said indication comprising a recommendation of at least one discharge unit.

2. The high-pressure cleaning system in accordance with claim 1, wherein the at least one predeterminable output parameter comprises at least one of the pressure of the cleaning liquid, a volumetric flow rate of the cleaning liquid and a dosage of a cleaning chemical admixable to the cleaning liquid.

3. The high-pressure cleaning system in accordance with claim 1, wherein the at least one output parameter is controllable by the high-pressure cleaning apparatus depending on the predetermination made by the user.

4. The high-pressure cleaning system in accordance with claim 1, wherein two or more discharge units are selectively connectable to the operating unit.

5. The high-pressure cleaning system in accordance with claim 1, wherein the high-pressure cleaning system comprises a discharge device which is connectable to the operating unit or on which is arranged an operating unit and which comprises two or more discharge units, one of which can be selectively selected and brought into fluid communication with the pump outlet.

6. The high-pressure cleaning system in accordance with claim 1, wherein the two or more discharge units comprise at least one of the following:
a high-pressure flat jet nozzle;
a high-pressure rotary nozzle;
a high-pressure pinpoint jet nozzle;
a low-pressure cleaning agent nozzle;
a foam nozzle;
a wash brush;
a surface cleaner, comprising a hood and a nozzle assembly movably arranged in a receiving space bounded by the hood, said nozzle assembly being drivable by pressurized cleaning liquid.

7. The high-pressure cleaning system in accordance with claim 1, wherein the at least one output parameter is predeterminable by at least one of the following:
a value or range of values of the at least one output parameter;
an operating level of the high-pressure cleaning apparatus, at least one output parameter having a different value or range of values in different operating levels;
a choice of a cleaning profile with regard to an object to be cleaned, at least one output parameter having a different value or range of values in different cleaning profiles.

8. The high-pressure cleaning system in accordance with claim 7, wherein at least one of two or more operating levels and cleaning profiles are selectably presented or selectably presentable to the user on the input unit in a manner coded by symbols that differ from one other.

9. The high-pressure cleaning system in accordance with claim 7, wherein the high-pressure cleaning system comprises a storage unit coupled to or integrated in the control unit in which at least one of an operating level and a cleaning profile is stored in a manner in which they are selectable via the input unit, wherein a value or range of values of at least one output parameter associated with the operating level or the cleaning profile is stored.

10. The high-pressure cleaning system in accordance with claim 9, wherein a wireless data connection is establishable with a spatially remote data processing device via the control unit and wherein data relating to at least one of an operating level and a cleaning profile are transmittable from the data processing device to the control unit and are storable in the storage unit for selection by the user.

11. The high-pressure cleaning system in accordance with claim 1, wherein the output unit is or comprises a visual output unit and wherein the indication is presentable on the output unit.

12. The high-pressure cleaning system in accordance with claim 11, wherein the user's predetermination of the at least one output parameter is presentable on the output unit.

13. The high-pressure cleaning system in accordance with claim 1, wherein the input unit comprises at least one switch, button, key, rotary knob and/or touch-sensitive screen for predetermining the at least one output parameter.

14. The high-pressure cleaning system in accordance with claim 1, wherein the input unit and the output unit form an integrated input/output unit.

15. The high-pressure cleaning system in accordance with claim 1, wherein the integrated input/output unit comprises a touch-sensitive screen for receiving the predetermination and outputting the indication.

16. The high-pressure cleaning system in accordance with claim 1, wherein the control unit forms, at least in part, an integrated unit with at least one of the input unit and the output unit.

17. The high-pressure cleaning system in accordance with claim 1, wherein at least one of the input unit, the output unit and the control unit are, at least in part, arranged on or comprised by the operating unit.

18. The high-pressure cleaning system in accordance with claim 1, wherein at least one of the input unit, the output unit and the control unit are, at least in part, arranged on or comprised by the high-pressure cleaning apparatus.

19. The high-pressure cleaning system in accordance with claim 1, wherein at least one of the input unit, the output unit and the control unit are, at least in part, arranged on or comprised by a portable accessory device.

20. The high-pressure cleaning system in accordance with claim 19, wherein data are wirelessly transmittable from the accessory device to the high-pressure cleaning apparatus and vice versa.

21. The high-pressure cleaning system in accordance with claim 1, wherein data are wirelessly transmittable from the operating unit to the high-pressure cleaning apparatus and vice versa.

22. The high-pressure cleaning system in accordance with claim 1, wherein the high-pressure cleaning system comprises a detection unit coupled to the control unit with which the discharge unit that is connected to the operating unit or the discharge unit that is arranged on the operating unit is determinable.

23. The high-pressure cleaning system in accordance with claim 22, wherein the detection unit is arranged on the operating unit or comprised thereby.

24. The high-pressure cleaning system in accordance with claim 22, wherein, when the discharge unit deviates from a discharge unit in accordance with the recommendation, a corresponding indication is providable by the control unit on the output unit.

25. A method for operating a high-pressure cleaning system comprising a high-pressure cleaning apparatus having a high-pressure pump for increasing the pressure of a cleaning liquid, and comprising two or more discharge units, for discharging the cleaning liquid, which are different from each other and which can be selectively brought into fluid communication with a pump outlet of the high-pressure pump, wherein the discharge units are connectable to an operating unit of the high-pressure cleaning system or wherein an operating unit is arranged on at least one discharge unit, wherein the high-pressure cleaning system comprises an input unit via which at least one output parameter is predetermined by a user, wherein the at least one output parameter is adjusted, in accordance with the predetermination, by a control unit, coupled to the input unit, of the high-pressure cleaning system, and wherein the high-pressure cleaning system comprises an output unit coupled to the control unit, on which output unit an indication depending on the predetermination made by the user is provided, said indication comprising a recommendation of at least one discharge unit.
